(19) United States
(12) Patent Application Publication
(10) Pub. No.: US 2018/0071161 A1
(43) Pub. Date: Mar. 15, 2018

(54) Comfort Device

(71) Applicant: Edward Lee O'Brien, Albuquerque, NM (US)

(72) Inventor: Edward Lee O'Brien, Albuquerque, NM (US)

(21) Appl. No.: 15/265,866

(22) Filed: Sep. 15, 2016

(51) Int. Cl. A61G 13/12; A61G 5/12; A47G 9/10

(52) U.S. Cl. CPC A61G 13/1235; A61G 2005/125; A47G 9/10; A61G 5/12

(57) ABSTRACT

The present invention is a comfort device that is comprised of a soft, yet firm pillow encased in a soft, cashmere-like covering. It can be held by patients, young and old, while receiving medical or dental care. It has padded handles to grasp when holding the pillow snug against one's body, to provide additional comfort and security.

### BACKGROUND

### 1. Field of the Invention

The invention relates generally to a comfort device, and in particular to people, to help calm someone in a stressful situation.

### 2. Description of Prior Art

Visiting the doctor or the dentist can be traumatic for children and for many adults who have the same fears. Holding on to a favorite stuffed toy may help to calm a small child, but older children and adults no longer carry stuffed toys to give them comfort when it is needed.

There exists a need for a comfort device for children and adults to hold when they are nervous about the treatment they are to receive.

There is still room for improvement in the art.

### SUMMARY OF THE INVENTION

The present invention is a comfort device that provides comfort for an adult person or child who are in a stressful environment such as a doctor's or dentist office.

The invention is a soft, yet firm pillow, encased in a soft, cashmere-like fabric encasement covering that can be held by patients, young and old, while receiving medical or dental care. It has padded handles to grasp when holding the pillow snug against one's body, to provide additional comfort and security.

Today's society is always seeking new ways to make receiving dental or medical care less traumatic for patients, and this is precisely why this product has been developed. The current invention is more efficient, effective and functional than the current art.

### BRIEF DESCRIPTION OF THE DRAWINGS

Without restricting the full scope of this invention, the preferred form of this invention is illustrated in the following drawings:

FIG. 1 shows a front view of the comfort device;

FIG. 2 shows a side view of the comfort device; and

FIG. 3 shows the components of the comfort device

### DESCRIPTION OF THE PREFERRED EMBODIMENT

There are a number of significant design features and improvements incorporated within the invention.

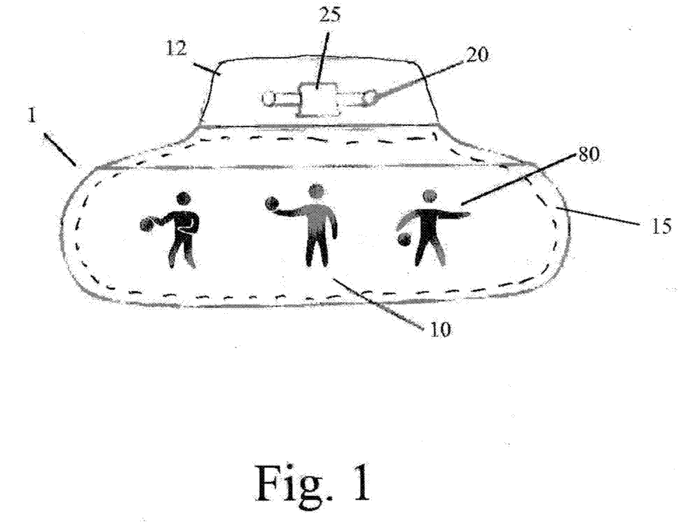

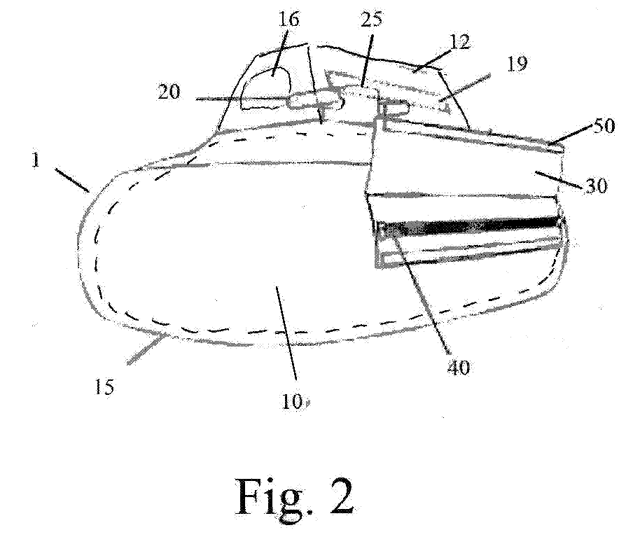

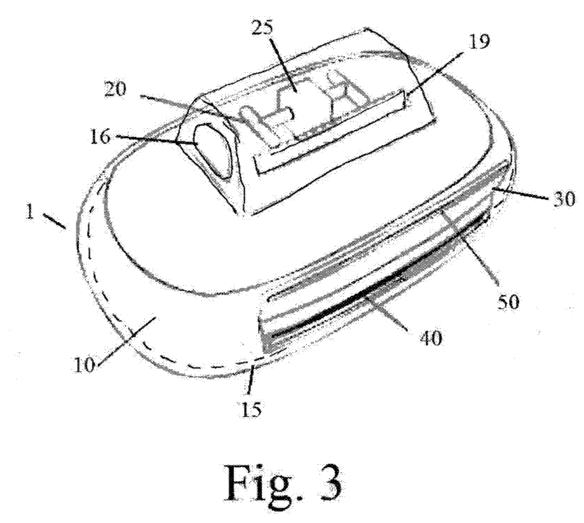

The current invention is directed to comfort device 1 as shown in FIGS. 1-3. The present invention comprises of a pillow 10, inside a fabric case 15, a pouch 12, a plurality of padded handles 20, a handle post 25, a zipper 40, a plurality of connector such as a hoop and latch connector.

The present invention is arranged in such a way as follows; the pillow 10 is placed in the fabric case 15 which is connected to the pouch 12. The plurality of padded handles are placed and are attached inside the center of the pouch 12 with the nylon cord. The zipper is placed on one side of the fabric case. The first Velcro piece is placed parallel to the zipper and the second Velcro piece is placed on one side of the pouch.

The current invention is a comfort device 1 for patients to hold on to when they are nervous about receiving treatment in a dental or medical care facility or any other stressful event. It has a base 10 which is a soft pillow like structure that is encased in the fabric case 15. The fabric case 15 is made of a material that which feels like cashmere. The fabric encasement 15 will cover the pillow 10 which is filled with a soft, hypo-allergenic material similar to any standard pillow filling material. Which is inserted and extracted through the opening at the zipper 40.

The fabric case 15 has a pouch 12 attached at the top of it. The pouch 12 is a rectangular structures with two openings 16 on the side. Inside the pouch 12 has a pair of padded handles 20. These handles 20 can be held as the fabric encasement 15 is pulled tightly against one's body to provide additional comfort and security. The user would reach through the openings 16 on the sides of the pouch 12.

In the preferred embodiment, there are two handles 20 extend out from a handle post 25 which is connected to and perpendicular to the fabric encasement 15. The handle post 25 is made of a sturdy but soft material and connected to the fabric encasement 15 using a connection means like a nylon cord.

The handles 20, in the preferred embodiment, are “T” shape and extend perpendicularly from the handle post 25. The handles 20 can be in a fixed position or may rotate depending on what feels more comfortable to the user. The handles 20 are connected to each other inside the pouch 12 with a nylon cord, and they, along with the handle post 25, should be removed prior to washing the cover. They can be accessed and removed through a pouch slot 19 which has a closing means such as a hoop and latch system.

The fabric encasement 15 is washable and the pillow content 10 can be removed through a zippered opening 40. The fabric encasement 15 has a zipper cover 30 which is a flap of material that covers the zipper 40 and is closed using an attachment means 50 such as a hoop and fastener strips. The zipper cover 30 covers the zipper 40 so that the hardness of the zipper 40 is covered.

The comfort device 1 can be available in different sizes: small for very young children, and medium and large sizes for teens and adults. The covers 15 can have decorative designs 80 on them as shown in FIG. 1. It is designed to be available in a variety of fun and colorful prints, including animal prints, flowers, clouds, smiley faces, rainbows, and any other happy prints, which will help to distract nervous patients.

### ADVANTAGES

The unique features of this product will provide the following benefits:
A soft pillow to provide comfort and security for medical and dental patients,
The zipper is covered by a flap of material, so it is hidden and will not scratch users, and
Patients of all ages will find holding this pillow may help to calm and distract them during highly stressful situations.

While the methods disclosed herein have been described and shown with reference to particular steps performed in a particular order, it is understood that these steps may be combined, sub-divided, or reordered to form an equivalent method without departing from the teachings of the embodiments. Accordingly, unless specifically indicated herein, the order and grouping of the steps is not a limitation of the embodiments. Furthermore, methods and mechanisms of the embodiments will sometimes be described in singular form for clarity. However, some embodiments may include multiple iterations of a method or multiple variations of a mechanism unless noted otherwise. For example, when a connection is disclosed in one embodiment, the scope of the embodiment is intended to also cover the use of multiple connections.

Certain features of the embodiments, which may have been, for clarity, described in the context of separate embodiments, may also be provided in various combinations in a single embodiment. Conversely, various features of the embodiments, which may have been, for brevity, described in the context of a single embodiment, may also be provided separately or in any suitable sub-combination. Embodiments described in conjunction with specific examples are presented by way of example, and not limitation. Moreover, it is evident that many alternatives, modifications, and variations will be apparent to those skilled in the art. It is to be understood that other embodiments may be utilized and structural changes may be made without departing from the scope of the embodiments.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device comprising:
a soft pillow encased in a fabric encasement with a plurality of handles connected to said fabric encasement.

2. A device according to claim 1 comprising:
having said fabric encasement filled with a soft material.

3. A device according to claim 2 comprising:
where the soft material is a pillow.

4. A device according to claim 1 comprising:
having a pouch connected to the fabric encasement and covering the handles.

5. A device according to claim 4 comprising:
having the pouch have an opening with a closing means.

6. A device according to claim 1 comprising:
having the handles be made of a soft material.

7. A device according to claim 1 comprising:
having the handles covered with a soft material.

8. A device according to claim 1 comprising:
having the handles connect to a handle post which is connected to the fabric encasement.

9. A device according to claim 1 comprising:
having the handles be in a “T” shape.

10. A device according to claim 1 comprising:
having the handles be fixed in place.

11. A device according to claim 1 comprising:
having the handles rotatable.

12. A device according to claim 1 comprising:
having the handles be removable.

13. A device according to claim 4 comprising:
having the fabric encasement have an opening allowing the pillow to be removed from the fabric encasement.

14. A device according to claim 13 comprising:
having the fabric encasement have a zipper opening.

15. A device according to claim 13 comprising:
having the fabric encasement have opening covered by a zipper cover.

16. A device according to claim 13 comprising:
having the zipper cover attach to the fabric encasement using an attachment means.

17. A device according to claim 17 comprising:
having the attachment means be hook and loop fasteners.

18. A process to comfort people in a stressful event comprising:
using the device in claim 1.

19. A device to comfort people in a stressful event comprising:
a pillow covered by a fabric encasement with a pouch connected to said fabric encasement having a plurality of padded handles.

20. A device according to claim 19 comprising:
having the handles be removable for washing of said fabric encasement.
